(19) United States
(12) Patent Application Publication
(10) Pub. No.: US 2025/0289292 A1
(43) Pub. Date: Sep. 18, 2025

(54) MULTI-COMPRESSOR OIL MIGRATION MITIGATION CLIMATE SYSTEM

(71) Applicant: Bergstrom, Inc., Rockford, IL (US)

(72) Inventors: Yevgeniy Beygel, Long Grove, IL (US); Brett Herrmann, Rochelle, IL (US); Alexander Victor Puzin, Cherry Valley, IL (US); Ian Boyes, Wimborne Dorset (GB)

(21) Appl. No.: 19/094,771

(22) Filed: Mar. 28, 2025

Related U.S. Application Data
(63) Continuation of application No. 17/972,932, filed on Oct. 25, 2022.
Application No. 17/972,932 is a continuation-in-part of application No. 16/922,855, filed on Jul. 7, 2020, now Pat. No. 11,479,086.
Application No. 16/922,855 is a continuation of application No. 16/133,599, filed on Sep. 17, 2018, now Pat. No. 10,703,173.
Application No. 16/133,599 is a continuation of application No. 15/280,876, filed on Sep. 29, 2016, now Pat. No. 10,081,226.
(60) Provisional application No. 62/378,135, filed on Aug. 22, 2016.
(60) Provisional application No. 63/347,544, filed on May 31, 2022.

(51) Int. Cl. B60H 1/32; B60H 1/00; F25B 31/00; F25B 49/02

(52) U.S. Cl. CPC B60H 1/3214; B60H 1/00849; B60H 1/00864; B60H 1/3223; B60H 1/323; F25B 31/004; F25B 49/022; F25B 49/027; B60H 2001/3238; B60H 2001/3255; B60H 2001/3272; F25B 2400/075; F25B 2600/01; F25B 2600/0251; F25B 2600/0253; F25B 2600/111; F25B 2700/2104; F25B 2700/2106

(57) ABSTRACT

Disclosed are climate systems and methods for control the climate systems. A climate system includes a refrigerant circuit, a first compressor, a second compressor, a first refrigerant-to-air heat exchanger, a second refrigerant-to-air heat exchanger, and a controller communicatively coupled to the first and second compressors. Respective outlets of the first and second compressors are fluidically coupled to the first refrigerant-to-air heat exchanger, the first refrigerant-to-air heat exchanger is fluidically coupled to the second refrigerant-to-air heat exchanger, and the second refrigerant-to-air heat exchanger is fluidically coupled with respective inlets of the first and second compressors. The fluidic connection between the second refrigerant-to-air heat exchanger and the first and second compressors includes a vertical split that is configured to mitigate or reduce the amount of compressor oil that migrates to dormant components.

### RELATED APPLICATIONS

This application is a continuation of U.S. application Ser. No. 17/972,932, filed Oct. 25, 2022, entitled “Multi-Compressor Oil Migration Mitigation Climate System,” which is a continuation-in-part of U.S. application Ser. No. 16/922,855, filed Jul. 7, 2020, now U.S. Pat. No. 11,479,086, entitled “Multi-Compressor Climate System,” which is a continuation of U.S. application Ser. No. 16/133,599, filed Sep. 17, 2018, now U.S. Pat. No. 10,703,173, entitled “Multi-Compressor Climate System,” which is a continuation of U.S. application Ser. No. 15/280,876, filed Sep. 29, 2016, now U.S. Pat. No. 10,081,226, entitled “Parallel Compressors Climate System,” which claims priority to U.S. Provisional Application Ser. No. 62/378,135, filed Aug. 22, 2016, entitled “Parallel Compressors Climate System,” each of which is incorporated by reference herein in its entirety.

Additionally, U.S. application Ser. No. 17/972,932, filed Oct. 25, 2022, entitled “Multi-Compressor Oil Migration Mitigation Climate System,” claims priority to U.S. Provisional Application Ser. No. 63/347,544, filed May 31, 2022, entitled “Multi-Compressor Oil Migration Mitigation Climate System,” which is also incorporated by reference herein in its entirety

### FIELD OF THE INVENTION

The present disclosure generally relates to climate systems and control methods therefor, and more particularly, to vehicle climate systems that use multiple compressors and control methods that can draw-back compressor oil to the compressors without the use of an oil equalization system.

### BACKGROUND

It is well known that nearly all compressors require a form of lubricant (e.g., oil) to cool, seal, or lubricate internal components. Typically, only static jet compressors and oil-free machines with rotors suspended in magnetic or air bearings are exempt from the need for some type of lubrication. In refrigeration systems that use compressors, a small portion of the compressor lubricant becomes entrained with the refrigerant and discharged from the compressor. The lubricant entrained in the refrigerant may cause several problems. For example, in a system with a single compressor, if too much lubricant is entrained in the refrigerant, the heat transfer and efficiency of the condenser and evaporator may be significantly reduced. In a system with two or more compressors, in addition to affecting heat transfer and efficiency of the condenser and evaporator, the entrained lubricant may not be returned to both compressors equally or properly, thereby providing too much lubricant to one compressor and too little to the other. This problem is exacerbated when the compressors are arranged in parallel.

Some conventional systems address this by using an oil equalization line system that connects the compressor crankcases or oil sumps via an oil equalization line. This approach usually requires the compressors having the same size and the same capacity and mounted at the same level or height. Other conventional systems use oil separators (either individual or common separators) to separate oil from the refrigerant and then return the separated oil back to the compressors. These systems are inherently complicated, more expensive and/or difficult to maintain and control.

Given the above background, there is a need in the art for climate systems and control methods that are simple, less expansive and/or easy to control and at the same time can realize the benefits of the parallel compressor configuration.

Additionally, in climate control systems that use multiple low-side components (i.e. compressors, evaporators, chillers, etc.), compressor oil can migrate and become trapped in dormant components, therefore reducing lubrication capability of the system. As such, systems that mitigate the transfer of compressor oil are needed.

The information disclosed in this Background section is provided solely to provide a general background of the embodiments described herein and is not an acknowledgement or suggestion that this information forms part of the prior art already known to a person skilled in the art.

### SUMMARY

Various aspects of the present disclosure provide climate systems and control methods that are simple to make and operate, are less expensive, and easier to control, while at the same time realizing the benefits of a parallel compressor configuration.

In one embodiment, a climate system for cooling a compartment of a vehicle is provided. The climate system includes a plurality of compressors, a condenser, an evaporator, refrigerant lines and a controller. The plurality of compressors is arranged in parallel for compressing refrigerant into a compressed refrigerant. The condenser is disposed downstream of the plurality of compressors for condensing the compressed refrigerant. The evaporator is disposed downstream of the condenser for evaporating the condensed refrigerant. The evaporator is thermally coupled to the compartment of the vehicle to cool the compartment. The refrigerant lines fluidly connect the plurality of compressors, the condenser, and the evaporator to form a refrigerant circuit for circulating the refrigerant. The controller is electrically coupled to the first and second compressors and configured to automatically and independently control operation of the first and second compressors to draw back compressor oil to the first and second compressors.

The plurality of the compressors includes a first compressor and a second compressor. In one embodiment, at least one of the first compressor and the second compressor is a twin rotary vane compressor. In another embodiment, one of the first compressor and the second compressor is a single rotary vane compressor. The first compressor includes a first refrigerant inlet, a first refrigerant outlet, and a first oil sump. The second compressor includes a second refrigerant inlet, a second refrigerant outlet, and a second oil sump. The first refrigerant inlet of the first compressor is fluidly connected to the second refrigerant inlet of the second compressor. The first refrigerant outlet of the first compressor is fluidly connected to the second refrigerant outlet of the second compressor. The first oil sump is independent of the second oil sump. In one embodiment, the first oil sump of the first compressor is independent of the second oil sump of the second compressor in that the first oil sump of the first compressor is not fluidly connected to the second oil sump of the second compressor. In another embodiment, the first oil sump of the first compressor is independent of the second oil sump of the second compressor in that the first oil sump and the second oil sump are not connected by an oil equalizing system.

In some embodiments, the controller automatically controls operations of the plurality of the compressors to draw back compressor oil to the compressors. In an embodiment, the controller operates the first compressor at a first low speed range for a first low-speed time period before turning off the first compressor to allow compressor oil drawn back to the first oil sump. Operating the first compressor at the first low speed range for the first low-speed time period is performed every time when the first compressor is turned off, every other time when the first compressor is to be turned off, or after the first compressor has been operated at a first high speed range for a first high-speed time period. In an embodiment, the controller operates the second compressor at a second low speed range for a second low-speed time period before turning off the second compressor to allow the compressor oil drawn back to the second oil sump. Operating the second compressor at the second low speed range for the second low-speed time period is performed every time when the second compressor is to be turned off, every other time when the second compressor is to be turned off, or after the second compressor is operated at a second high speed range for a second high-speed time period.

In one embodiment, the climate system further includes a sensor for measuring an atmosphere temperature and a thermostat for receiving a desired temperature and detecting an interior temperature in the compartment. The controller is electrically coupled to the sensor and the thermostat and controls operations of the first and second compressors in accordance with the atmospheric temperature, the interior temperature and the desired temperature.

In one embodiment, the climate system further includes a first air blower and/or a second air blower. The first air blower is positioned proximate the condenser, and configured to do one or more of the following: blowing air over the condenser to cool the condenser, and vent interior air of the compartment to reduce the thermal load of the compartment. The second air blower is configured to suck in ambient or fresh air into the compartment of the vehicle, if the interior temperature exceeds both the desired temperature and the atmosphere temperature. The first and second air blowers can be operated simultaneously, alternately or independently. In some embodiments, the climate system is integrated with an existing air conditioning system of the vehicle in that the first air blower and/or the second air blower are shared by the climate system and the existing air conditioning system.

Another embodiment provides a first method for controlling a climate system. The first method includes: (a) receiving a desired temperature for the compartment and an atmosphere temperature outside of the vehicle; (b) monitoring an interior temperature in the compartment of the vehicle; (c) determining whether the interior temperature is higher than the desired temperature; (d) determining whether the interior temperature is higher than the atmosphere temperature; (c) turning on the first air blower to vent interior air in the compartment, if the interior temperature exceeds both the desired temperature and the atmosphere temperature; (f) determining whether the thermal load of the compartment exceeds a first thermal threshold, if the interior temperature is higher than the desired temperature but lower than or equal to the atmosphere temperature; (g) turning on the first compressor or the second compressor if the thermal load of the compartment is less than or equal to a first thermal threshold; and (h) turning on both the first compressor and the second compressor if the thermal load of the compartment exceeds the first thermal threshold.

In some embodiments, the first method further includes one or more additional or optional steps. In one embodiment, the first method includes: operating the first compressor at a first low speed range for a first low-speed time period before turning off the first compressor to allow compressor oil drawn back to the first oil sump; and/or operating the second compressor at a second low speed range for a second low-speed time period before turning off the second compressor to allow the compressor oil drawn back to the second oil sump. In some embodiments, operating the first compressor at the first low speed range for the first low-speed time period is performed every time when the first compressor is turned off, every other time when the first compressor is to be turned off, or after the first compressor has been operated at a first high-speed range for a first high-speed time period. Operating the second compressor at the second low speed range for the second low-speed time period is performed every time when the second compressor is to be turned off, every other time when the second compressor is to be turned off, or after the second compressor is operated at a second high speed range for a second high-speed time period.

In some embodiments, the first method includes: determining whether it is needed to draw back compressor oil to the first compressor based on whether the first compressor has been running at a first high speed range and for how long; and determining whether it is needed to draw back the compressor oil to the second compressor based on whether the second compressor has been running at a second high speed range and for how long. Based on the determination, the first method, in some embodiments, operates the first compressor at a first low speed range for a first low-speed time period to draw back compressor oil to the first compressor if the first compressor has been operated at the first high speed range for a first high-speed time period, and/or operates the second compressor at a second low speed range for a second low-speed time period to draw back compressor to the second compressor if it is determined that the second compressor has been operated at the second high speed range for a second high-speed time period.

In one embodiment, the first method further includes: turning on a second air blower installed in the vehicle to suck in ambient or fresh air into the compartment of the vehicle, if the interior temperature exceeds both the desired temperature and the atmosphere temperature. In another embodiment, the first method further includes: opening or closing a door in a duct of the existing air conditioning system of the vehicle before turning on the second air blower, wherein the opening or closing of the door allows the second air blower to blow the ambient or fresh air into the compartment of the vehicle.

Yet other embodiments provide a second method for controlling a climate system. The second method includes: (a) receiving a desired temperature for the compartment and an atmosphere temperature outside of the vehicle; (b) determining whether a thermal load of the compartment exceeds a first thermal threshold; (c) turning on the first compressor or the second compressor if the thermal load of the compartment is less than or equal to a first thermal threshold; (d) turning on both the first compressor and the second compressor if the thermal load of the compartment exceeds the first thermal threshold; and (e) performing one or more of the following: operating the first compressor at a first low speed range for a first low-speed time period before turning off the first compressor to allow compressor oil drawn back to the first oil sump; and operating the second compressor at a second low speed range for a second low-speed time period before turning off the second compressor to allow the compressor oil drawn back to the second oil sump.

In some embodiments, prior to operating the first and/or second compressor at a low speed range, the second method further includes one or more of the following additional or optional steps: determining whether it is needed to draw back compressor oil to the first compressor based on whether the first compressor has been running at a first high speed range and for how long; and determining whether it is needed to draw back the compressor oil to the second compressor based on whether the second compressor has been running at a second high speed range and for how long. After the determination, in some embodiments, the second method operates the first compressor at a first low speed range for a first low-speed time period to draw back compressor oil to the first compressor if the first compressor has been operated at the first high speed range for a first high-speed time period; and operates the second compressor at a second low speed range for a second low-speed time period to draw back compressor to the second compressor if it is determined that the second compressor has been operated at the second high speed range for a second high-speed time period.

In another embodiment, a specific refrigerant plumbing design has been developed to mitigate or prevent compressor oil from migrating into dormant components (e.g., inactive compressors) as well as low-side components of the climate system (e.g., an evaporator, a suction line, and any accessory components located within the suction line). A climate system for conditioning air within a compartment of a vehicle is disclosed. The climate system includes a refrigerant circuit, a first compressor (102; FIGS. 1, 2 and 8) fluidly coupled to the refrigerant circuit, a second compressor (104; FIGS. 1, 2 and 8) fluidly coupled to the refrigerant circuit. The first compressor including a first compressor inlet and a first compressor outlet, and the second compressor including a second compressor inlet and a second compressor outlet. The climate system further includes a first refrigerant-to-air heat exchanger (118; FIGS. 1 and 2) fluidly coupled to the first compressor outlet and the second compressor outlet via a first set of one or more refrigerant lines (e.g., 122-1, 122-2, 122-3; FIGS. 1, and 2). The first refrigerant-to-air heat exchanger is thermally coupled to an exterior of the vehicle and forms part of the refrigerant circuit. The climate system further includes a second refrigerant-to-air heat exchanger (120; FIGS. 1 and 2) (i) fluidly coupled to the first refrigerant-to-air heat exchanger via a second set of one or more refrigerant lines (e.g., 122-4) and (ii) fluidly coupled to the first compressor inlet and the second compressor inlet via a third set of one or more refrigerant lines (e.g., 122-5, 122-6, 122-7; FIGS. 1, and 2). The second refrigerant-to-air heat exchanger is thermally coupled to the compartment of the vehicle and forms part of the refrigerant circuit. A first refrigerant line of the third set of one or more refrigerant lines includes a first section (e.g., 122-6; FIGS. 1, 2, and 8) configured to cause any compressor oil mixed in the refrigerant to flow from a first lower elevation (e.g., 811; FIG. 8) to a first higher elevation (e.g., 813; FIG. 8) before flowing to the first compressor to restrict a flow of compressor oil to the first compressor when the first compressor is inactive. A second refrigerant line of the third set of one or more refrigerant lines includes a second section (e.g., 122-7; FIGS. 1, 2, and 8) configured to cause any compressor oil mixed in the refrigerant to flow from a second lower elevation (e.g., 811; FIG. 8) to a second higher elevation (e.g., 813; FIG. 8) before flowing to the second compressor to restrict a flow of compressor oil to the second compressor when the second compressor is inactive. The climate system further includes a controller (124; FIGS. 1 and 2) communicatively coupled to the first and second compressors and including instructions that are configured to selectively activating and deactivating the first and second compressors.

Additionally, the specific refrigerant plumbing design disclosed herein is configured to provide a consistent OCR level for a climate system. The consistent OCR level for a climate system can be any OCR level required for a particular climate system to operate efficiently (i.e., such that the heat transfer and efficiency of the condenser and evaporator are not significantly reduced) while also lubricating components of the climate system. For example, in some embodiments, the second compressor maintains a second predetermined oil circulation ratio (OCR) (e.g., between 3 percent to 8 percent) or an oil mass of greater than a second predetermined oil mass (e.g., 40 g) while the climate system is in operation; and the first compressor maintains a first predetermined OCR (e.g., between 3.5 percent to 8 percent). Additionally, in some embodiments, a starting and ending charge level of the first compressor is at least a first predetermined baseline oil mass (e.g. 135 g); and a starting and ending charge level of the second compressor is at least a second predetermined baseline oil mass (e.g., 150 g). Values of the first predetermined OCR, the second predetermined OCR, the second predetermined oil mass, the first predetermined baseline oil mass, and the second predetermined baseline oil mass are based on the configuration of the climate system and/or the one or more components of the climate system. The OCR percentage and oil amount requirements can be different for each climate system.

In some embodiments, the first compressor is configured to be driven by an internal combustion engine (e.g., a belt driven compressor or other mechanical compressor); and the second compressor is an electrically driven compressor. A skilled artisan will appreciate that any compressor drive combination can be used in the climate system between belt, electric, hydraulic, direct drive, etc.

In some embodiments, the first section of the first refrigerant line extends longitudinally from the first lower elevation to the first higher elevation at a first angle (e.g., angle a) from a centerline of the first lower elevation. In some embodiments, the first angle is between 5 to 90 degrees. In some embodiments, the first angle is between 15 to 60 degrees. In some embodiments, the first angle is between 30 to 45 degrees. In some embodiments, the second section of the second refrigerant line extends longitudinally from the second lower elevation to the second higher elevation at a second angle (θ) from a centerline of the second lower elevation. In some embodiments, the second angle is between 5 to 90 degrees. In some embodiments, the second angle is between 15 to 60 degrees. In some embodiments, the second angle is between 30 to 45 degrees. In some embodiments, the first angle and the second angle are the same. Alternatively, in some embodiments, the first and second angles are distinct.

In some embodiments, the first lower elevation is the same as the second lower elevation. Alternatively, in some embodiments, the first lower elevation is distinct from the second lower elevation. In some embodiments, the first higher elevation is the same as the second higher elevation. Alternatively, in some embodiments, the first higher elevation is distinct from the second higher elevation.

In some embodiments, the first compressor and the second compressor are coupled in parallel with one another. In some embodiments, the controller further includes instructions that are configured to selectively adjust operation of the first and second compressors. In some embodiments, selectively adjusting operation of the first and second compressors includes adjusting a speed of the first and/or second compressors. In some embodiments, the third set of refrigerant lines restricts the flow of compressor oil from the active compressor to the inactive compressor without adjustments, via the controller, to the operation of the first and second compressors.

The systems and methods of the present disclosure have other features and advantages that will be apparent from or are set forth in more detail in the accompanying drawings, which are incorporated herein, and the following Detailed Description.

### BRIEF DESCRIPTION OF THE DRAWINGS

The accompanying drawings, which are incorporated into and constitute a part of this specification, illustrate one or more embodiments of the present application and, together with the detailed description, serve to explain the principles and implementations of the application.

FIG. 1 is a block diagram illustrating a climate system in accordance with some embodiments.

FIG. 2 is a block diagram illustrating the climate system of FIG. 1, including some additional and/or optional components.

FIG. 3 is a flowchart illustrating a first exemplary method for controlling a climate system in accordance with some embodiments.

FIG. 4 is a flowchart illustrating the first exemplary method of FIG. 3, including some additional and/or optional steps.

FIG. 5 is a flowchart illustrating the first exemplary method of FIG. 3, including some other additional and/or optional steps.

FIG. 6 is a flowchart illustrating a second exemplary method for controlling a climate system in accordance with some embodiments.

FIG. 7 illustrates a climate system including horizontal refrigerant lines coupling an evaporator with one or more compressors, in accordance with some embodiments.

FIGS. 8A-8C illustrate a climate system including vertical refrigerant lines coupling an evaporator with one or more compressors, in accordance with some embodiments.

### DETAILED DESCRIPTION

Reference will now be made in detail to implementations of the present application as illustrated in the accompanying drawings. The same reference indicators will be used throughout the drawings and the following detailed description to refer to the same or like parts. Those of ordinary skill in the art will realize that the following detailed description of the present application is illustrative only and is not intended to be in any way limiting. Other embodiments of the present application will readily suggest themselves to such skilled persons having benefit of this disclosure.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Many modifications and variations of this disclosure can be made without departing from its spirit and scope, as will be apparent to those skilled in the art. The specific embodiments described herein are offered by way of example only, and the disclosure is to be limited only by the terms of the appended claims, along with the full scope of equivalents to which such claims are entitled.

Embodiments of the present disclosure are described in the context of climate systems for use in vehicles and methods for controlling the climate systems. As used herein, a vehicle can be a car, a van, a truck, a bus, a trailer, or other automobiles. A climate system of the present disclosure in general includes two or more compressors that are connected fluidly in parallel but with no oil equalizing system disposed there between. The climate system also includes a condenser (e.g., a first refrigerant-to-air heat exchanger), an evaporator (e.g., a second refrigerant-to-air heat exchanger) and refrigerant lines fluidly connecting the compressors, condenser and evaporators to form a refrigerant circuit. A controller is included in the climate system and a novel method is used to control the compressors to draw back compressor oil that is entrained in the refrigerant or carried away by the refrigerant during operation of the climate system. As used herein, the term “compressor oil” refers to a material (e.g., oil, lubricant, sealant) that is used to cool, seal, or lubricate components (e.g., gears) of a compressor. In some embodiments, the compressors are controlled independently based on thermal loads.

With no oil equalizing system, the climate system of the present disclosure is more compact and at the same time more flexible compared to conventional systems. For instance, the climate system can have compressors of different sizes and different capacities, and the compressors do not need to be mounted at the same level, height or elevation. Accordingly, the climate system of the present disclosure can be installed in various ways such as mounted on a rear wall of a sleeper compartment in a vehicle, and/or integrated with other components in the existing air conditioning systems of the vehicle. In addition, by controlling the compressors independently based on thermal loads, the present disclosure improves the system's overall efficiency. In addition, the climate system of the present disclosure requires less parts and thus has a higher reliability and lower cost than climate systems with more parts.

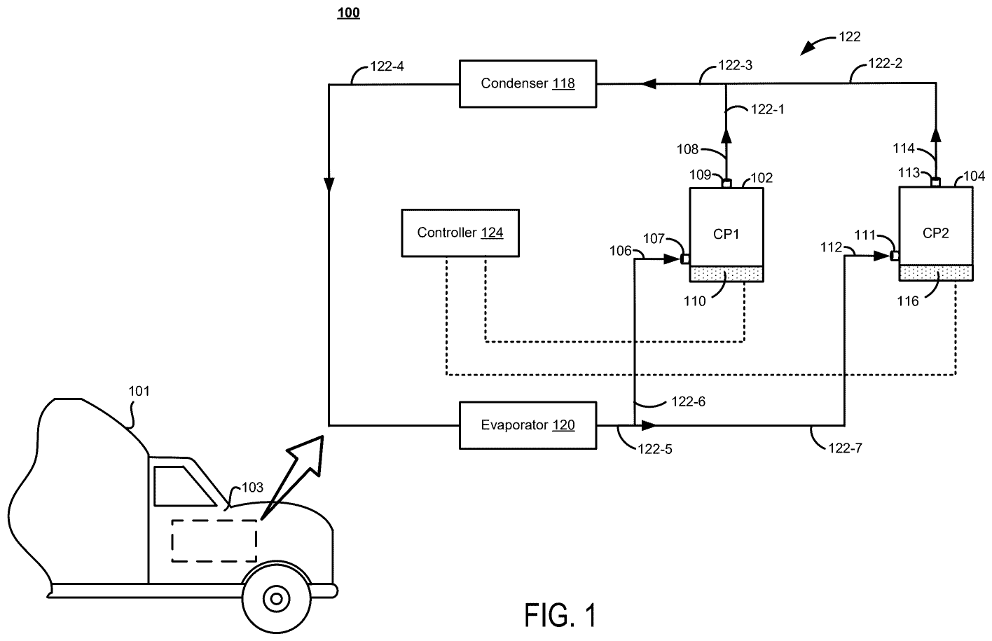

By way of illustration, FIG. 1 depicts a climate system (100) including a plurality of compressors such as a first compressor (102) and a second compressor (104), a condenser (118), an evaporator (120), refrigerant lines and a controller (124). The first compressor (102) includes a first refrigerant inlet (106) and a first refrigerant outlet (108). The second compressor (104) includes a second refrigerant inlet (112) and a second refrigerant outlet (114). The first compressor (102) and the second compressor (104) are fluidly connected to each other in parallel in terms of the refrigerant. For example, in the illustrated embodiment, the first refrigerant inlet (106) of the first compressor (102) is fluidly connected to the second refrigerant inlet (112) of the second compressor (104) by refrigerant lines (e.g., 122-6, 122-7); and the first refrigerant outlet (108) of the first compressor (102) is fluidly connected to the second refrigerant outlet (114) of the second compressor (104) by refrigerant lines (e.g., 122-1, 122-2).

The first compressor (102) further includes a first oil sump (110) and the second compressor (104) includes a second oil sump (116). The first oil sump (110) of the first compressor (102) is independent of the second oil sump (116) of the second compressor (104). As used herein, the term “oil sump” refers to a reservoir that houses lubricant for cooling, sealing, or lubricating internal components such as gears of a compressor. In some cases, the oil sump is a tank, an oil pan, or simply a space at the bottom of a crankcase of a compressor. In some embodiments, independency between the first oil sump (110) and the second oil sump (116) is characterized in that the first oil sump (110) of the first compressor (102) is not fluidly connected to the second oil sump (116) of the second compressor (104). As used herein, the first oil sump “not fluidly connected” to the second oil sump refers to one or more of the following configurations: (i) the first and second oil sumps are not connected by any oil equalizing system (e.g., oil line or oil conduit) that is used in conventional systems to flow oil between different oil sumps and to keep oil in different oil sumps at the same level, (ii) the first and second oil sumps are not connected by a common oil separator that is used in conventional systems to separate the oil from the refrigerant, and (iii) the first and second oil sumps are not connected by a common suction header or conduit that is used in conventional systems to return the oil after being separated from the refrigerant to the oil sumps.

In some embodiments, both the first and second compressors are rotary vane compressors. In one embodiment, at least one of the first compressor (102) and the second compressor (104) is a twin rotary vane compressor. In another embodiment, one of the first compressor (102) and the second compressor (104) is a single rotary vane compressor. It will be appreciated that the first and second compressors are not limited to rotary vane (either single or twin) compressors. Any other suitable compressors including reciprocating, scroll, screw, or centrifugal compressors can be used in the climate system of the present disclosure. In some embodiments, the first refrigerant inlet (106) of the first compressor (102) includes two or more refrigerant intake ports (107), and the first refrigerant outlet (108) of the first compressor (102) includes two or more refrigerant discharge ports (109). Similarly, in some embodiments, the second refrigerant inlet (112) of the second compressor (104) includes two or more refrigerant intake ports (111), and the second refrigerant outlet (114) of the second compressor (104) includes two or more refrigerant discharge ports (113). In some embodiments, the two or more refrigerant intake ports are connected to one another. In some embodiments, the two or more refrigerant outlet ports are connected to one another.

The condenser (118) is disposed downstream of the plurality of compressors and fluidly connected to the plurality of compressors by refrigerant lines (e.g., 122-1, 122-2, 122-3). The evaporator (120) is disposed downstream of the condenser (118) and fluidly connected to the condenser (118) by a refrigerant line (e.g., 122-4). In some embodiments, the evaporator (120) is also fluidly connected to the plurality of compressors by refrigerant lines (e.g., 122-5, 122-6, 122-7), thus forming a refrigerant circuit for circulating the refrigerant.

During operation of the climate system (100), the plurality of compressors compresses a refrigerant into a compressed refrigerant, the condenser (118) condenses the refrigerant that has been compressed by the plurality of compressors, and the evaporator (120) evaporates the refrigerant that has been condensed by the condenser (118). The evaporator (120) is thermally coupled to a compartment (103) of the vehicle (101) to cool the compartment. As used herein, the term “thermally coupled” refers to one or more of the following: (i) the evaporator is mounted within a corresponding compartment (103) to exchange heat with that compartment or with the air in that compartment, and (ii) the evaporator is coupled with a device (e.g., heat exchanger or air blower) which introduces conditioned air into that compartment (103). The compartment (103) can be a cab compartment, a sleeper compartment, a combination of cab and sleeper compartments, or any space in a vehicle.

As shown in FIG. 1, the controller (124) is electrically coupled to the first and second compressors. The controller (124) is configured to automatically and independently control operation of the first and second compressors to draw back compressor oil to the first and second compressors. In some embodiments, to draw compressor oil that is entrained in the refrigerant or carried away by the refrigerant back to the first oil sump (110), the controller (124) operates the first compressor (102) at a first low speed range for a first low-speed time period before turning off the first compressor (102). In one embodiment, operating the first compressor (102) at the first low speed range for the first low-speed time period is performed every time when the first compressor (102) is to be turned off. In another embodiment, operating the first compressor (102) at the first low speed range for the first low-speed time period is performed every other time when the first compressor (102) is to be turned off. In some embodiments, whether to operate the first compressor (102) at a low speed range to draw back compressor oil is determined based on how long the first compressor (102) has been running at a high speed range. For example, in some embodiments, to draw compressor oil back to the first oil sump (110), the controller (124) operates the first compressor (102) at the first low speed range for the first low-speed time period after the first compressor (102) has been operated at a first high speed range for a first high-speed time period.

Similarly, to draw compressor oil that is entrained in the refrigerant or carried away by the refrigerant back to the second oil sump (116), in some embodiments, the controller (124) operates the second compressor (104) at a second low speed range for a second low-speed time period before turning off the second compressor (104). In one embodiment, operating the second compressor (104) at the second low speed range for the second low- speed time period is performed every time when the second compressor (104) is to be turned off. In another embodiment, or operating the second compressor (104) at the second low speed range for the second low-speed time period is performed every other time when the second compressor (104) is to be turned off. In some embodiments, whether to operate the second compressor (104) at a low speed range to draw back compressor oil is determined based on how long the second compressor (104) has been running at a high speed range. For example, in some embodiments, to draw compressor oil back to the second oil sump (116), the controller (124) operates the second compressor (104) at the second low speed range for the second low-speed time period after the second compressor (104) has been operated at a second high speed range for a second high-speed time period.

In some embodiments, the first or second low speed range is between 1500 and 3000 rpm (revolutions per minute), between 1500 and 4500 rpm, or between 1500 and 6500 rpm. In some embodiments, the first or second low-speed time period before turning off the first or second compressor (104) is between 5 and 20 seconds, between 20 and 100 seconds, or between 100 and 200 seconds. In some embodiments, the first or second high speed range is between 1500 and 3000 rpm, between 1500 and 4500 rpm, or between 1500 and 6500 rpm. In some embodiments, the first or second high-speed time period is between 5 and 20 seconds, between 20 and 100 seconds, or between 100 and 200 seconds

In some embodiments, the controller (124) is configured to automatically and independently control operation of the first and second compressors based at least partially on a thermal load of the compartment. In some embodiments, the controller (124) turns on the first or the second compressor when the thermal load of the compartment is equal to or less than a first threshold, and turns on both the first and the second compressors when the thermal load of the compartment exceeds the first threshold. In an embodiment, the first and second compressors have the same capacity. In another embodiment, the first and second compressors have different capacities. In some embodiments, the first threshold of the thermal load corresponds to the capacity of the first or the second compressor. In some embodiments, the first threshold of the thermal load is between 0.4 KW (kilowatts) and 0.8 kW, between 0.4 KW and 1.0 kW, or between 0.4 KW and 1.6 kW.

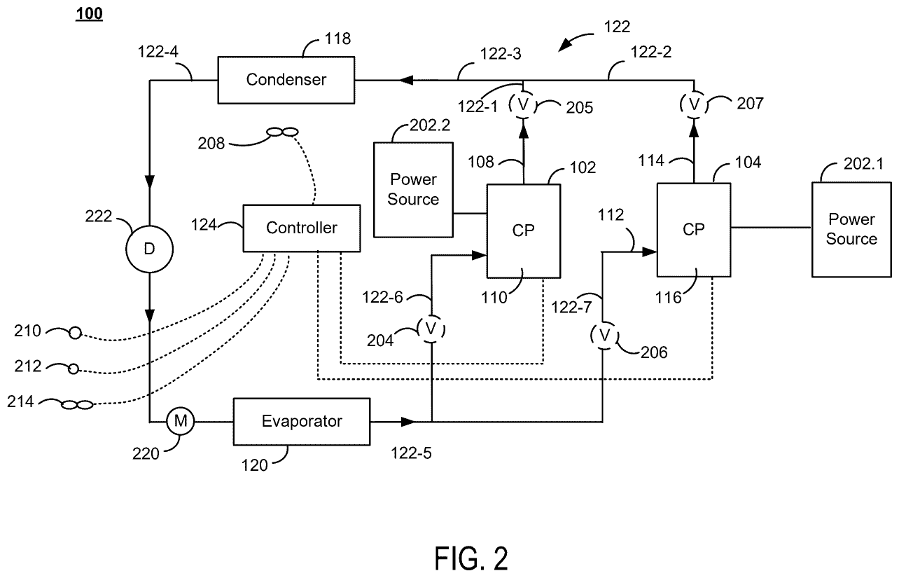

Referring to FIG. 2, in some embodiments, the climate system (100) of the present disclosure further includes other additional or optional components. For instance, in some embodiments, the climate system (100) further includes a first plurality of flow control valves such as a first flow control valve (204) and a second flow control valve (206). The first flow control valve (204) is disposed upstream of the first compressor (102) and configured to selectively restrict or permit flow of the refrigerant to the first compressor (102). The second flow control valve (206) is disposed upstream of the second compressor (104) and configured to selectively restrict or permit flow of the refrigerant to the second compressor (104). In some additional embodiments, the climate system (100) further includes a second plurality of flow control valves such as a third flow control valve (205) and a fourth flow control valve (207). The third flow control valve (205) is disposed downstream of the first compressor (102) and configured to selectively restrict flow of the refrigerant to the first compressor (102) (e.g., when the first compressor is dormant). The fourth flow control valve (207) is disposed downstream of the second compressor (104) and configured to selectively restrict flow of the refrigerant to the second compressor (104) (e.g., when the second compressor is dormant).

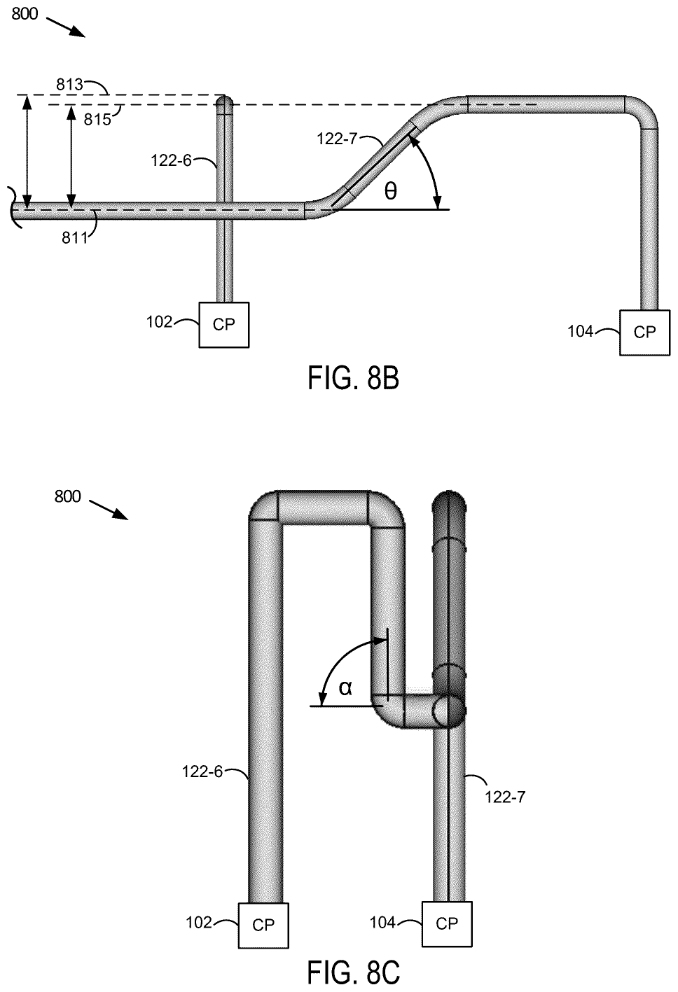

Additionally or alternatively, in some embodiments, a refrigerant line coupling the evaporator (120) to the first compressor (102) and the second compressor (104) includes a vertical split between the first compressor (102) and the second compressor (104). More specifically, the refrigerant line coupling the evaporator (120) to the first compressor (102) and the second compressor (104) splits into a first refrigerant line (122-6) that couples to the evaporator (120) to an inlet of the first compressor (102), and is partially vertical with respect to a position of the first compressor (102); a second refrigerant line (122-7) that couples to the evaporator (120) to an inlet of the second compressor (104), and is partially vertical with respect to a position of the second compressor (104). Vertical, for purposes of this disclosure, is an angle that is greater than zero such that the respective refrigerant line is above the respective compressor. In some embodiments, each vertical refrigerant line (e.g., the first refrigerant line (122-6) and the second refrigerant line (122-7)) has the same or distinct vertical angles. Examples of the different vertical angles are described below with reference to FIGS. 8A-8C.

The vertical angles of the first refrigerant line (122-6) and the second refrigerant line (122-7) restrict the flow of compressor oil to inactive compressors as well as fluidically coupled low-side components of the climate system (e.g., an evaporator, a suction line, and any accessory components located within the suction line). In particular, the use of partially vertical refrigerant lines reduces the amount of compressor oil trapped in dormant components of the climate system (100) or low-side components of the climate system further ensuring that there is adequate lubrication for each compressor. In some embodiments, the first refrigerant line (122-6) and the second refrigerant line (122-7) cause the second compressor to maintain a second predetermined oil circulation ratio (OCR) (e.g., at least 3 percent) or an oil mass of greater than a second predetermined oil mass (e.g., 40 g) while the climate system (100) is in operation. In some embodiments, the first refrigerant line (122-6) and the second refrigerant line (122-7) cause the second compressor to maintain an OCR between 3 percent and 8 percent while the climate system (100) is in operation. In some embodiments, the first refrigerant line (122-6) and the second refrigerant line (122-7) cause the first compressor to maintain a first predetermined OCR (e.g., at least 3.5 percent) while the climate system (100) is in operation. In some embodiments, the climate system (100) including the first refrigerant line (122-6) and the second refrigerant line (122-7) has a first predetermined starting and a first predetermined ending charge level (e.g., at least 135 g) for the first compressor (102), and a second predetermined starting and a second predetermined ending charge level (e.g., at least 150 g) for the second compressor (104). Values of the first predetermined OCR, the second predetermined OCR, the second predetermined oil mass, the first predetermined baseline oil mass (e.g., the first predetermined starting and the first predetermined ending charge level), and the second predetermined baseline oil mass (e.g., the second predetermined starting and the second predetermined ending charge level) are based on the configuration of the climate system and/or the one or more components of the climate system. The OCR percentage and oil amount requirements can be different for each climate system.

In some embodiments, the climate system (100) further includes one or more air blowers. For instance, in the illustrated embodiment, the climate system (100) further includes a first air blower (208) positioned proximate the condenser (118). The first air blower (208) is configured to blow air over the condenser (118) to cool the condenser (118), and/or to vent interior air of the compartment to reduce the thermal load of the compartment. In some embodiments, the climate system (100) further includes a second air blower (214) electrically coupled to the controller (124). The second air blower (214) is configured and controlled by the controller (124) to vent the interior air of the compartment to outside, and/or to suck in the ambient or fresh air into the compartment. In some embodiments, the climate system (100) is integrated with an existing air conditioning system of the vehicle. In such cases, the first air blower (208) and/or the second air blower (214) are shared by the climate system (100) and the existing air conditioning system. In an embodiment, the first and second air blowers are mounted in the same compartment (e.g., sleep compartment or cab compartment). In another embodiment, the first and second air blowers are mounted in different compartments, for instance, the first air blower (208) in the sleeper compartment and the second air blower (214) in the cab compartment.

To automatically control the compressors, air blowers and/or other components in the system, in some embodiments, the climate system (100) of the present disclosure further includes a sensor (210) for measuring an atmosphere temperature and a thermostat (212) for setting a desired temperature and monitoring an interior temperature in the compartment. In such embodiments, the controller (124) is electrically coupled to the sensor (210) and the thermostat (212) and automatically control operations of other components (e.g., air blower, compressor) based on the atmosphere temperature, the interior temperature and the settings (e.g., desired temperature). For instance, when the interior temperature is higher than both of the atmosphere temperature and the desired temperature, the controller (124) turns on the first air blower (208) to vent interior air from the compartment before turning on the first or second compressor. In embodiments with a second air blower (214), the controller (124) additionally or optionally turns on the second air blower (214) to suck in the ambient or fresh air into the compartment. As such, the thermal load is reduced before turning on the compressors, and consequently the overall efficiency of the climate system is improved. When the interior temperature is lowered to the atmosphere temperature and the desired temperature is lower than the atmosphere temperature, the controller (124) turns on the first and/or second compressors to cool the compartment further down to the desired temperature. The controller (124) operates the first and/or second compressors (e.g., controlling the speed of a compressor) in accordance with the desired temperature and the atmosphere temperature.

In some embodiments, one or more compressors are driven by electrical power source or sources (202). In an embodiment, all of the compressors are driven by electrical power source or sources (202). In some embodiments, at least one compressor is driven by the internal combustion engine of the vehicle. By way of illustration, FIG. 2 shows the first compressor (102) is configured to be driven by the internal combustion engine, and the second compressor (104) is an electrically driven compressor. The second compressor (104) is configured to operate when the internal combustion engine of the vehicle is not running.

Continuously referring to FIG. 2, in some embodiments, the climate system (100) of the present disclosure further includes a metering device (220) disposed upstream of the evaporator (120). The metering device (220) is configured to control the flow of the refrigerant into the evaporator (120). Examples of the metering device (220) include a thermal expansion valve, a capillary tube, or the like. In some embodiments, the metering device (220) is electrically coupled to the controller (124) and its operation is automatically controlled by the controller (124).

In some embodiments, the climate system (100) further includes a receiver/drier (222) disposed at the refrigerant line (122-4) between the condenser (118) and the evaporator (120). The receiver/drier (222) is configured to temporarily store the refrigerant, absorb moisture from the refrigerant, or both.

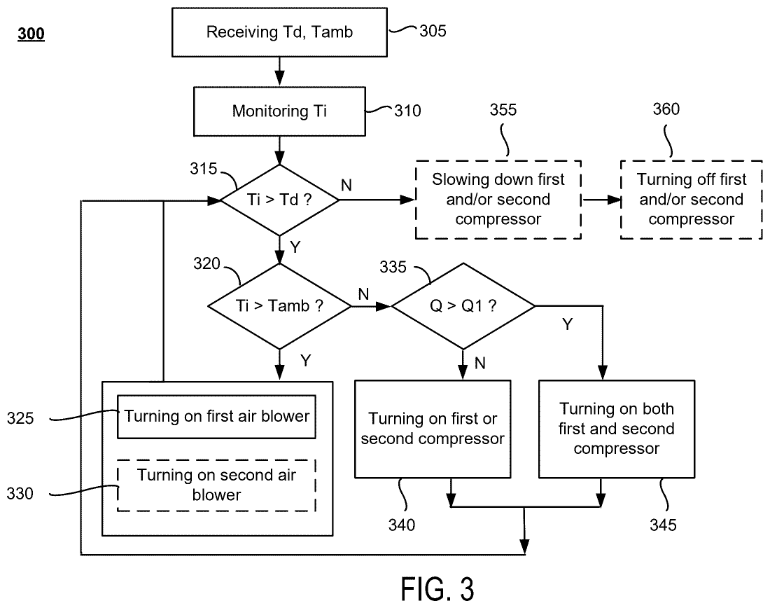

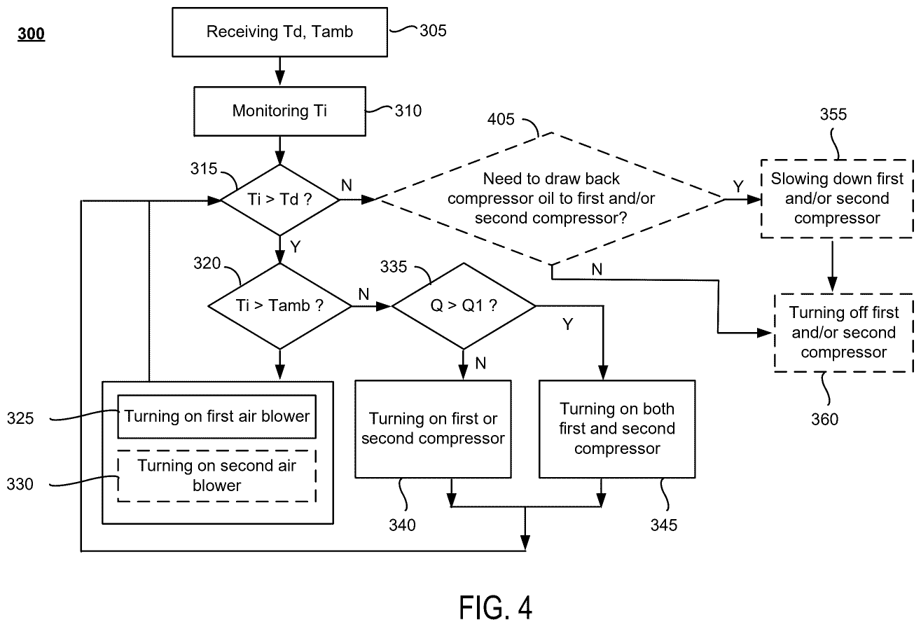

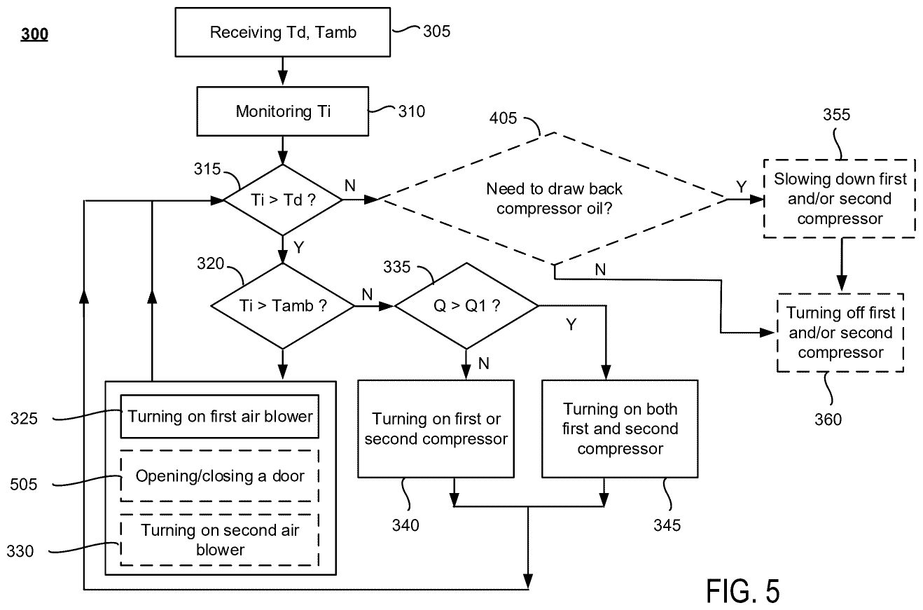

Turning now to FIGS. 3-5, there depict a first method (300) for controlling climate systems in accordance with some embodiments of the present disclosure. For illustration purpose, the first method (300) is described in the context of a climate system that includes a first compressor and a second compressor in parallel, i.c., the refrigerant inlets of the first and second compressors are fluidly connected to each other and refrigerant outlets of the first and second compressors are fluidly connected to each other. The climate system further includes a condenser disposed downstream of the first and second compressors and fluidly connected to the first and second compressors, and a first air blower positioned proximate the condenser and configured to blow air over the condenser. The climate system is installed in a vehicle for cooling a compartment of the vehicle.

In some embodiments, the first method (300) is governed by instructions that are stored in and executed by a controller such as the controller (124) illustrated in FIGS. 1 and 2. In some embodiments, the first method (300) is governed by instructions that are stored in and executed by an electronic device other than the controller (124) illustrated in FIGS. 1 and 2.

In some embodiments, the first method (300) includes: receiving a desired temperature for the compartment and an atmosphere temperature outside of the vehicle (step 305); monitoring an interior temperature in the compartment of the vehicle (step 310); determining whether the interior temperature is higher than the desired temperature (step 315); determining whether the interior temperature is higher than the atmosphere temperature (step 320); turning on the first air blower to vent interior air in the compartment, if the interior temperature exceeds both the desired temperature and the atmosphere temperature (step 325); determining whether the thermal load of the compartment exceeds a first thermal threshold, if the interior temperature is higher than the desired temperature but lower than or equal to the atmosphere temperature (step 335); turning on the first compressor or the second compressor if the thermal load of the compartment is less than or equal to a first thermal threshold (step 340); and turning on both the first compressor and the second compressor if the thermal load of the compartment exceeds the first thermal threshold (step 345).

In some embodiments, the climate system includes a second air blower, or the climate system is coupled to an existing air conditioning system and an air blower of the existing air conditioning system serves as a second air blower to the climate system. In such embodiments, the first method (300) includes an additional or optional step (step 330) that turns on the second air blower to suck in ambient or fresh air into the compartment of the vehicle, if the interior temperature exceeds both the desired temperature and the atmosphere temperature. The first and second air blowers may be operated simultaneously, alternately, or independently.

In some embodiments, the first method (300) automatically turns off the first compressor and/or the second compressor when the interior temperature is lowered to the desired temperature or when cooling is no longer desired (step 360). In some embodiments, before turning off the first compressor and/or second compressor, the first method (300) operates the first compressor at a first low speed range for a first low-speed time period before turning off the first compressor to allow compressor oil drawn back to the first oil sump and/or operates the second compressor at a second low speed range for a second low- speed time period before turning off the second compressor to allow the compressor oil drawn back to the second oil sump (step 355).

In some embodiments, operating the first compressor at the first low speed range for the first low-speed time period is performed every time when the first compressor is to be turned off or every other time when the first compressor is to be turned off. Similarly, in some embodiments, operating the second compressor at the second low speed range for the second low-speed time period is performed every time when the second compressor is to be turned off or every other time when the second compressor is to be turned off.

In some embodiments, the first method (300) further includes an additional or optional step 405, to determine whether it is needed to draw back compressor oil to one or more compressors. If it is determined that drawing back compressor oil is needed for a compressor, the first method (300) proceeds to step 355 to slow down that compressor (e.g., operating that compressor at a low speed range for a period of time) before turning it off at step 360. Otherwise, the first method (300) proceeds to step 360 to turn off that compressor. In some embodiments, the determination is based on how long the compressor has been running at a high speed range. For example, in some embodiments, operating the first compressor at the first low speed range for the first low-speed time period is performed after the first compressor is operated at a first high speed range for a first high-speed time period. Operating the second compressor at the second low speed range for the second low-speed time period is performed after the second compressor is operated at a second high speed range for a second high-speed time period.

In some embodiments, the second air blower is selectively in fluidic communication with the ambient, a fresh air system of the vehicle or the compartment of the vehicle through a duct such as a pipe, a conduit, a channel, a tube, or the like. In some embodiments, a door is implemented to control the air flow. In such embodiments, the first method (300) includes an additional or optional step 505, which opens or closes the door before turning on the second air blower to allow the second air blower to blow the ambient or fresh air into the compartment of the vehicle.

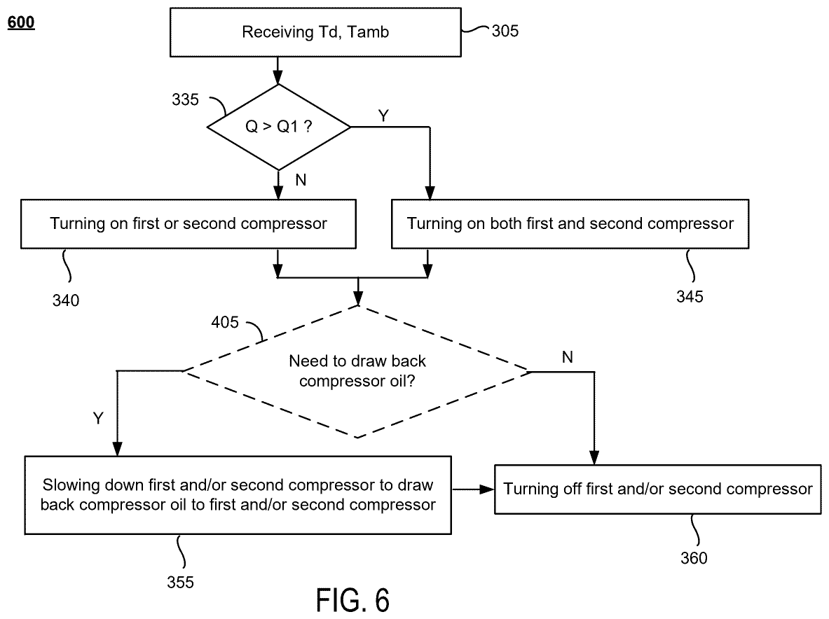

Referring to FIG. 6, there depicts a second method (600) for controlling climate systems in accordance with some embodiments of the present disclosure. For illustration purpose, the second method (600) are described in the context of a climate system that includes a first compressor and a second compressor in parallel, i.c., the refrigerant inlets of the first and second compressors are fluidly connected to each other and refrigerant outlets of the first and second compressors are fluidly connected to each other. The climate system further includes a condenser disposed downstream of the first and second compressors and fluidly connected to the first and second compressors. The climate system is installed in a vehicle for cooling a compartment of the vehicle.

Like the first method (300), in some embodiments, the second method (600) is governed by instructions that are stored in and executed by a controller such as the controller (124) illustrated in FIGS. 1 and 2. In some embodiments, the second method (600) is governed by instructions that are stored in and executed by an electronic device other than the controller (124) illustrated in FIGS. 1 and 2.

In some embodiments, the second method (600) includes: receiving a desired temperature for the compartment and an atmosphere temperature outside of the vehicle (step 305); determining whether a thermal load of the compartment exceeds a first thermal threshold (step 335); turning on the first compressor or the second compressor if the thermal load of the compartment is less than or equal to a first thermal threshold (step 340); turning on both the first compressor and the second compressor if the thermal load of the compartment exceeds the first thermal threshold (step 345); and performing one or more of the following: operating the first compressor at a first low speed range for a first low-speed time period before turning off the first compressor to allow compressor oil drawn back to the first oil sump; and operating the second compressor at a second low speed range for a second low-speed time period before turning off the second compressor to allow the compressor oil drawn back to the second oil sump (step 355).

In some embodiments, prior to operating the first and/or second compressor at a low speed range (step 355), the second method (600) further include one or more of the following additional or optional steps: determining whether it is needed to draw back compressor oil to the first compressor based on whether the first compressor has been running at a first high speed range and for how long; and determining whether it is needed to draw back the compressor oil to the second compressor based on whether the second compressor has been running at a second high speed range and for how long (step 405). Based on the results of the determination, in some embodiments, the second method (600) further includes one or more of the following: operating the first compressor at a first low speed range for a first low-speed time period to draw back compressor oil to the first compressor if the first compressor has been operated at the first high speed range for a first high-speed time period; and operating the second compressor at a second low speed range for a second low-speed time period to draw back compressor to the second compressor if it is determined that the second compressor has been operated at the second high speed range for a second high-speed time period.

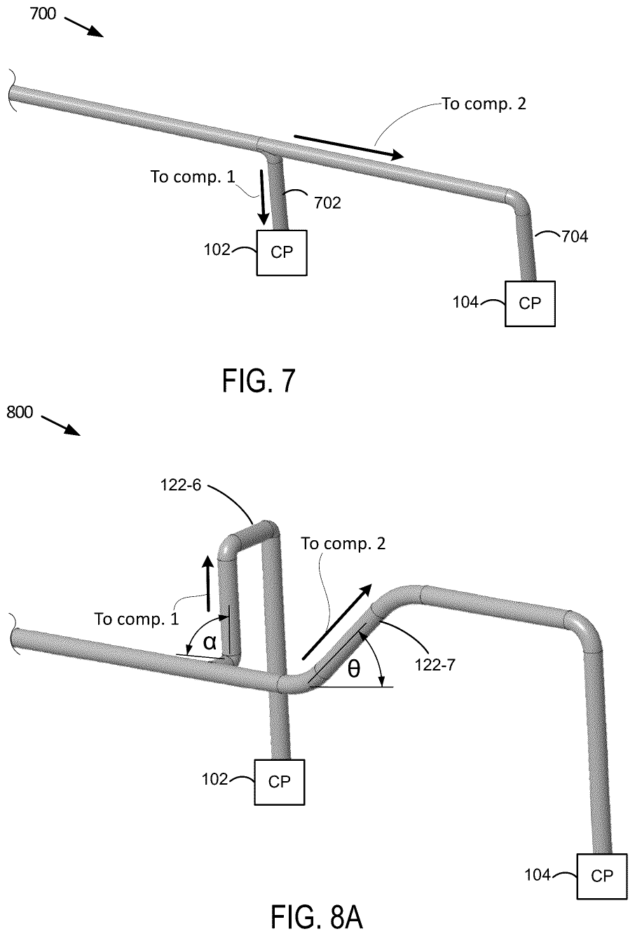

FIG. 7 illustrates a climate system including horizontal refrigerant lines coupling an evaporator with one or more compressors, in accordance with some embodiments. In particular, climate system (700) includes a first horizontal refrigerant line (702) and a second horizontal refrigerant line (704) coupling an evaporator (e.g., evaporator 120; FIGS. 1 and 2) to the first and second compressors (102) and (104). The horizontal configuration of the refrigerant lines does not mitigate or reduce the flow of compressor oil to dormant or inactive compressors without additional mitigation. Without additional mitigation, climate control system 700 causes compressor oil to migrate from the second compressor (104), e.g., an electrical compressor, to the first compressor (102), e.g., a mechanical compressor, during operation resulting in inadequate lubrication for the compressors. In order to control the flow of compressor oil between the first and second compressors, climate system 700 utilizes any method described above and shown in reference to FIGS. 3-6.

FIGS. 8A-8C illustrate a climate system including vertical refrigerant lines coupling an evaporator with one or more compressors, in accordance with some embodiments. The climate system (800) can include one or more components described above in reference to FIGS. 1 and 2. The climate system (800) includes a first refrigerant line (122-6) and a second refrigerant line (122-7) coupling an evaporator (e.g., evaporator 120; FIGS. 1 and 2) to the first and second compressors (102) and (104). The partially vertical configuration of the refrigerant lines mitigates or reduces the flow of compressor oil to dormant or inactive compressors without additional mitigation. In particular, the first refrigerant line (122-6) fluidly couples to the first compressor (102) inlet and is at least partially vertical with respect to a position of the first compressor (102) such that compressor oil is caused to travel upwards before reaching the first compressor (102) restricting a flow of the compressor oil to the first compressor (102) while the first compressor (102) is inactive; and the second refrigerant line (122-7) fluidly couples to the second compressor (104) inlet and is at least partially vertical with respect to a position of the second compressor (104) such that compressor oil is caused to travel upwards before reaching the second compressor (104) restricting a flow of the compressor oil to the second compressor (104) while the first compressor (104) is inactive. Use of a vertical split allows the climate system (800) to mitigate or reduce the flow of compressor oil to dormant components without adjusting operation of the compressors and/or the use of flow control valves.

In FIG. 8B, the respective heights of the vertical split are shown. In some embodiments, the first refrigerant line (122-6) includes a first section configured to cause any compressor oil mixed in the refrigerant to flow from a first lower elevation (811) to a first higher elevation (813) before flowing to the first compressor (102) to restrict a flow of compressor oil to the first compressor (102) when the first compressor (102) is inactive. Similarly, the second refrigerant line (122-7) includes a second section configured to cause any compressor oil mixed in the refrigerant to flow from a second lower elevation (not shown) to a second higher elevation (815) before flowing to the second compressor (104) to restrict a flow of compressor oil to the second compressor (104) when the second compressor (104) is inactive. In some embodiments, the first lower elevation (811) and the second lower elevation are the same or distinct. Similarly, in some embodiments, the first higher elevation (813) and the second higher elevation (815) are the same or distinct. In some embodiments, the respective elevations are measured from a flat surface (e.g., a ground). For example, the climate system (800) can be incorporated in a vehicle and the different elevations are measured from the ground to the height of the respective sections. The elevations are based on the zenith height for a respective section of refrigerant line. Additionally, a lower elevation for purposes of this disclosure, in some embodiments, means having a height less than a height to which it is compared. Similarly, a higher elevation for purposes of this disclosure, in some embodiments, means having a height greater than a height to which it is compared.

In some embodiments, the first section of the first refrigerant line (122-6) extends longitudinally from the first lower elevation (811) to the first higher elevation (813) at a first angle (e.g., α; FIG. 8C) from a centerline (e.g., imaginary line parallel with the first lower elevation (811)) of the first lower elevation (811). Similarly, in some embodiments, the second section of the second refrigerant line (122-7) extends longitudinally from the second lower elevation (which in FIG. 8 is the same as the first lower elevation (811)) to the second higher elevation (815) at a second angle (e.g., θ) from a centerline (e.g., imaginary line parallel with the second lower elevation) of the second lower elevation. In some embodiments, the first and second angles α and θ are greater than zero. In some embodiments, the first and second angles α and θ are between 5 to 90 degrees. In some embodiments, the first and second angles α and θ are between 15 to 60 degrees. In some embodiments, the first and second angles α and θ are between 30 to 45 degrees. Alternatively, in some embodiments, the first and second angles α and θ are greater than 90 degrees but less than 180 degrees. The first and second angles α and θ can be the same or distinct.

In FIG. 8C, an alternate view of the vertical split is shown. In some embodiments, the first refrigerant line (122-6) is at least partially vertical with respect to a position of the first compressor (102). For example, the first refrigerant line (122-6) can have an angle a such that it is not horizonal with the first compressor (102). Angle α, in some embodiments, is greater than zero degrees. In some embodiments, angle α is between 5 to 15 degrees, between 15 to 30 degrees, between 30 to 45 degrees, between 45 to 90, etc. In some embodiments, angle α is perpendicular with respect to a position of the first compressor (102). Similarly, the second refrigerant line (122-7) is partially vertical with respect to a position of the second compressor (104). For example, the second refrigerant line (122-7) can have an angle θ such that it is not horizonal with the second compressor (104). Angle θ, in some embodiments, is greater than zero degrees. Angle θ can be the same or different than angle a.

The climate system (800) can mitigate or reduce the transfer of compressor oil between dormant components for different operating speeds of the first and second compressors (102) and (104), for different operation times of the first and second compressors (102) and (104), and for a number of different cycles of the first and second compressors (102) and (104). For example, the first compressor (102) can operate at a speed between 900 RPM to 2500 RPM and the second compressor (104) can operate at a speed between 1100 RPM to 1800 RPM while maintaining a first predetermined OCR (e.g. at least 3.5% to 8%) for the first compressor (102) and maintaining a second predetermined OCR (e.g., at least 3% to 8%) for the second compressor (104). The above values are of the first compressor, the second compressor, the first predetermined OCR, and the second predetermined OCR, are based on a particular configuration of a climate system and/or the one or more components of the climate system. As such the above values can be different for different climate systems.

While the climate system (800) can mitigate or reduce the flow of compressor oil to dormant or inactive compressors without adjusting operation of the compressors and/or use of one or more flow valves (e.g., a first flow control valve (204) and a second flow control valve (206); FIG. 2), as described above in reference to FIG. 3-6, the different techniques can be combines to further mitigate or prevent the transfer of compressor oil between dormant components.

While the primary examples discussed herein relate to a climate system used in a vehicle, it is also contemplated that the climate system can be used in other machines, such as construction and agricultural machines. The climate system disclosed herein can be incorporated in any mobile thermal management applications. For example, the climate system including vertical refrigerant lines coupling an evaporator with one or more compressors described above in FIG. 8 can also be incorporated in drills, draglines, tractors, buildings, office spaces, etc.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will be understood that, although the terms “first,” “second,” etc. may be used herein to describe various elements, these elements should not be limited by these terms. These terms are only used to distinguish one element from another. For example, a first compressor could be termed a second compressor, and, similarly, a second compressor could be termed a first compressor, without changing the meaning of the description, so long as all occurrences of the “first compressor” are renamed consistently and all occurrences of the “second compressor” are renamed consistently.

What is claimed is:

1. A climate system for conditioning air within a compartment of a vehicle, comprising:
a refrigerant circuit;
a first compressor fluidly coupled to the refrigerant circuit, where the first compressor includes a first compressor inlet and a first compressor outlet;
a second compressor fluidly coupled to the refrigerant circuit, the second compressor including a second compressor inlet and a second compressor outlet;
a first refrigerant-to-air heat exchanger fluidly coupled to the first compressor outlet and the second compressor outlet via a first set of one or more refrigerant lines, wherein the first refrigerant-to-air heat exchanger is thermally coupled to an exterior of the vehicle and forms part of the refrigerant circuit;
a second refrigerant-to-air heat exchanger (i) fluidly coupled to the first refrigerant-to-air heat exchanger via a second set of one or more refrigerant lines and (ii) fluidly coupled to the first compressor inlet and the second compressor inlet via a third set of one or more refrigerant lines, wherein:
the second refrigerant-to-air heat exchanger is thermally coupled to the compartment of the vehicle and forms part of the refrigerant circuit, and
a first refrigerant line of the third set of one or more refrigerant lines includes a first section configured to cause any compressor oil mixed in the refrigerant to flow from a first lower elevation to a first higher elevation before flowing to the first compressor to restrict a flow of compressor oil to the first compressor when the first compressor is inactive; and
a second refrigerant line of the third set of one or more refrigerant lines includes a second section configured to cause any compressor oil mixed in the refrigerant to flow from a second lower elevation to a second higher elevation before flowing to the second compressor to restrict a flow of compressor oil to the second compressor when the second compressor is inactive; and
a controller communicatively coupled to the first and second compressors and including instructions that are configured to selectively activating and deactivating the first and second compressors.
